(19) United States
(12) Patent Application Publication
(10) Pub. No.: US 2008/0266365 A1
(43) Pub. Date: Oct. 30, 2008

(54) Ink-jet head

(75) Inventors: Young-Seuck Yoo, Seoul (KR); Jae-Woo Joung, Suwon-si (KR); Won-Chul Sim, Seongnam-si (KR); Young-Jae Kim, Suwon-si (KR); Pil-Joong Kang, Jinju-si (KR); Chang-Sung Park, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/078,796

(22) Filed: Apr. 4, 2008

(30) Foreign Application Priority Data
Apr. 27, 2007 (KR) 10-2007-0041531

(51) Int. Cl. B41J 2/045; B41J 2/175

(52) U.S. Cl. 347/70; 347/85

(57) ABSTRACT

An ink-jet head is disclosed. The ink-jet head may include: a chamber containing an ink; a reservoir connected with the chamber to supply the ink to the chamber; a restrictor connected with the chamber and the reservoir to control a flow of the ink; a nozzle connected with the chamber to jet the ink, and located at a position corresponding to where a pressure supplied to the chamber is the maximum; and an actuator supplying a pressure to the chamber such that the ink is jetted. The ink-jet may be operated with a lower driving voltage, and the ink may be jetted in a more stable manner.

### CROSS-REFERENCE TO RELATED APPLICATIONS

This application claims the benefit of Korean Patent Application No. 10-2007-0041531, filed with the Korean Intellectual Property Office on Apr. 27, 2007, the disclosure of which is incorporated herein in its entirety by reference.

### BACKGROUND

1. Technical Field

The present invention relates to an ink-jet head.

2. Description of the Related Art

An ink-jet head is an apparatus for jetting droplets through a small nozzle by transforming electric signals to physical forces.

FIG. 1 is a cross-sectional view of an ink-jet head according to the related art. In the arrangement shown in FIG. 1, when a displacement of the membrane 5 is generated by an actuator 6, an ink contained in a chamber 3 is moved toward a nozzle 4 to be jetted.

The conduit structures in the head and the actuator 6 must be designed to provide optimum performance, in order to obtain the highest efficiency. As such, the design of the restrictor 2, which serves to provide resistance during the supply or the jetting of the ink, and the location of the nozzle 4, etc., are important factors in designing the ink-jet head.

In the case of an ink-jet head according to the related art, ink is jetted through a reservoir 1, a restrictor 2, a chamber 3, and a nozzle 4 by a force caused by a displacement generated in the chamber 3. As shown in FIG. 1, the nozzle 4 may be located at an outer portion of the chamber 3.

This arrangement has the disadvantage that the displacement of the center portion, which provides the maximum displacement, cannot be fully utilized when the actuator 6 is operated over the chamber 3. Also, crosstalk may occur, due to a change in pressure generated in the reservoir 1.

### SUMMARY

One aspect of the present invention provides an ink-jet head having a nozzle positioned in consideration of the pressure supplied to the chamber, so that the ink-jet head can be operated with a lower driving voltage.

Another aspect of the invention provides an ink-jet head that includes: a chamber containing an ink; a reservoir connected with the chamber to supply the ink to the chamber; a restrictor connected with the chamber and the reservoir to control a flow of the ink; a nozzle connected with the chamber to jet the ink, and located at a position corresponding to where a pressure supplied to the chamber is the maximum; and an actuator supplying a pressure to the chamber such that the ink is jetted.

The nozzle may be located at a position corresponding to a center portion of the actuator or the chamber.

Multiple restrictors may be formed, where the restrictors may be formed in a balanced arrangement.

A membrane may cover the chamber, and the actuator may include a piezoelectric element coupled to the membrane.

Additional aspects and advantages of the present invention will become apparent and more readily appreciated from the following description, including the appended drawings and claims, or may be learned by practice of the invention.

### BRIEF DESCRIPTION OF THE DRAWINGS

FIG. 1 is a cross-sectional view of an ink-jet head according to the related art.

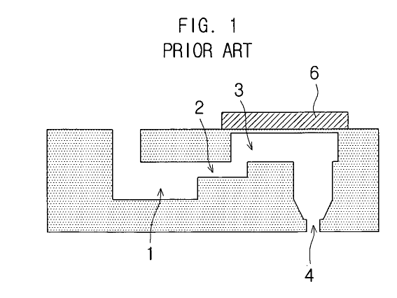

FIG. 2 is a cross-sectional view of an ink-jet head according to an embodiment of the present invention.

FIG. 3 is a bottom view of an ink-jet head according to an embodiment of the present invention.

### DETAILED DESCRIPTION

The ink-jet head according to certain embodiments of the invention will be described below in more detail with reference to the accompanying drawings. Those components that are the same or are in correspondence are rendered the same reference numeral regardless of the figure number, and redundant explanations are omitted.

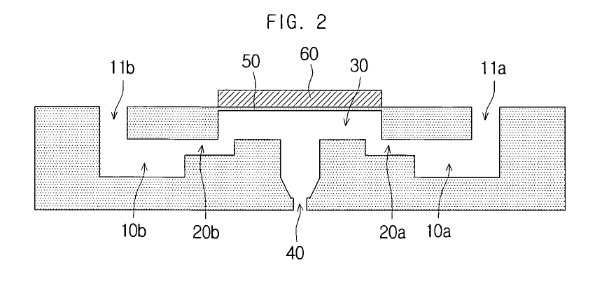

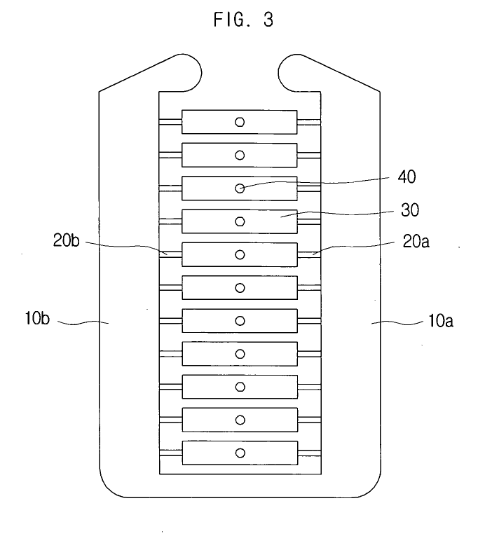

FIG. 2 is a cross-sectional view of an ink-jet head according to an embodiment of the present invention, and FIG. 3 is a bottom view of an ink-jet head according to an embodiment of the present invention. In FIGS. 2 and 3, there are illustrated reservoirs 10a, 10b, inlets 11a, 11b, restrictors 20a, 20b, chambers 30, nozzles 40, a membrane 50, and an actuator 60.

The reservoirs 10a, 10b may contain an ink, and may provide the ink to the chamber 30 through the restrictors 20a, 20b described below. The reservoirs 10a, 10b may receive the ink from the outside through inlets 11a, 11b.

Each of the restrictors 20a, 20b may serve as a channel that connects the chamber 30 with a reservoir 10a, 10b, and provide ink to the chamber 30 from the reservoir 10a, 10b. A restrictor 20a, 20b may be formed with a cross-sectional area smaller than that of a reservoir 10a, 10b. Also, the restrictors 20a, 20b may control the amount of ink provided from the reservoirs 10a, 10b to the chamber 30 when a pressure is provided to the chamber 30 by an actuator 60

The chamber 30 may be connected with the reservoirs 10a, 10b by the restrictors 20a, 20b. One side of the chamber 30 that is not connected with the restrictors 20a, 20b may be connected with a nozzle 40. Therefore, the chamber 30 may receive the ink from the reservoirs 10a, 10b and provide the ink to the nozzle 40, whereby printing may take place.

One side of the chamber 30 may be covered by the membrane 50, and the actuator 60 may be joined with the upper surface of the membrane 50 corresponding to the location of the chamber 30. A piezoelectric element may be used for the actuator 60.

The piezoelectric element may be joined onto the upper side of the membrane 50 corresponding to the location of the chamber 30, and may generate vibrations. The piezoelectric element may generate vibration, according to the electrical power supplied to the piezoelectric element, to supply a driving pressure through the membrane 50 to the chamber 30.

The nozzle 40 may be connected with the chamber 30, and may receive the ink from the chamber 30 to jet the ink. When a vibration generated by the actuator 60 is provided to the chamber 30, a pressure may be supplied to the chamber 30, at which the nozzle 40 may jet the ink by the pressure.

In order to increase the efficiency of jetting, the nozzle may be located at a position corresponding with where the pressure supplied to the chamber is maximum. Due to the structural characteristics of the ink-jet head, the pressure supplied to the chamber is not uniform, and a maximum pressure is provided at a particular position.

With this in consideration, the nozzle 40 may be located at a position corresponding with where the pressure supplied to the chamber 30 is maximum, so that the ink may be jetted efficiently. That is, compared to the related art, the same jetting performance may be obtained with a lower driving voltage.

The distribution of pressure supplied to the chamber 30 may depend on various factors, including the shape of the actuator 60 and the thickness of the membrane 50. For example, if the actuator 60 is a rectangular parallelepiped or a circular cylinder, and the thickness of the membrane is uniform, the nozzle may be located at a position corresponding to a center portion of the actuator 60, as in the example shown in FIG. 2.

If the actuator 60 provides a vibration through the entire surface on one side of the chamber 30, the nozzle 40 may be located at a position corresponding to a center portion of the chamber 30, so that substantially the same effect as that described above may be obtained.

The channel for providing ink to the chamber 30 may be diversified with multiple restrictors, as in the example shown in FIG. 2, to provide a smooth, continuous flow of ink within the ink-jet head. As a result, the chamber 30 may receive ink from reservoirs 10a, 10b through various channels, and the ink may be jetted in a stable manner.

That is, since the flow of the ink is diversified, the ink may not be isolated in a particular space. And even though one of the restrictors is stopped up, the ink may be provided through other restrictor so that the ink-jet head may be operated stably.

Here, multiple restrictors 20a, 20b may be formed in a balanced arrangement. That is, if there are two restrictors 20a, 20b, as in the example shown in FIGS. 2 and 3, the restrictors 20a, 20b may be arranged symmetrically.

With the restrictors 20a, 20b arranged symmetrically, the distribution of pressure in the ink-jet head may be balanced, so that the ink-jet head may be operated in a stable manner.

As set forth with reference to certain embodiments of the invention, an ink-jet head may include a nozzle located at a position corresponding with where the pressure supplied to the chamber is maximum, and may include various channels for providing ink to the chamber. Such an ink-jet head may be operated with a lower driving voltage, and the ink may be jetted in a more stable manner.

While the present invention has been described with reference to particular embodiments, it is to be appreciated that various changes and modifications may be made by those skilled in the art without departing from the spirit and scope of the present invention, as defined by the appended claims and their equivalents. As such, many embodiments other than those set forth above can be found in the appended claims.

What is claimed is:

1. An ink-jet head comprising:
a chamber containing an ink;
a reservoir connected with the chamber to supply the ink to the chamber;
a restrictor connected with the chamber and the reservoir to control a flow of the ink;
a nozzle connected with the chamber to jet the ink, the nozzle located at a position corresponding to where a pressure supplied to the chamber is the maximum; and
an actuator configured to supply a pressure to the chamber such that the ink is jetted.

2. The ink-jet head of claim 1, wherein the nozzle is located at a position corresponding to a center portion of the actuator.

3. The ink-jet head of claim 1, wherein the nozzle is located at a position corresponding to a center portion of the chamber.

4. The ink-jet head of claim 1, wherein a plurality of restrictors are formed.

5. The ink-jet head of claim 4, wherein the plurality of restrictors are formed in a balanced arrangement.

6. The ink-jet head of claim 1, further comprising a membrane covering the chamber,
wherein the actuator comprises a piezoelectric element coupled to the membrane.
